(19) United States
(12) Patent Application Publication
(10) Pub. No.: US 2026/0276097 A1
(43) Pub. Date: Sep. 17, 2026

(54) DISCHARGE CONTROL DEVICE

(71) Applicant: MITSUBISHI HEAVY INDUSTRIES ENGINE & TURBOCHARGER, LTD., Sagamihara-shi, Kanagawa (JP)

(72) Inventor: Hisao OGAWA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 19/168,031

(22) PCT Filed: Jan. 25, 2024
(86) PCT No.: PCT/JP2024/002202

§ 371 Date: Sep. 23, 2025

(30) Foreign Application Priority Data
Mar. 30, 2023 (JP) 2023-056795

(51) Int. Cl. F16K 15/02

(52) U.S. Cl. CPC F16K 15/028

(57) ABSTRACT

According to one aspect of the present disclosure, a discharge control device comprises a housing internally having a pressure space that communicates with a discharge flow path at one side in the axial direction, a valve body disposed inside the housing, and an anchor member disposed around the valve body and having a valve seat surface. The housing has a recessed section formed in one side inner end surface inside the housing, the recessed section defining the pressure space with one side end surface of the valve body. One side end surface of the anchor member includes a first seal section that abuts the one side inner end surface of the housing and forms a seal surface, and a first recess section that is made up of an annular recess that is formed facing the first recess section on the outer circumferential side of the second seal section.

### TECHNICAL FIELD

The present disclosure relates to a discharge control device.

The present application claims priority based on Japanese Patent Application No. 2023-056795 filed in Japan on Mar. 30, 2023, the contents of which are incorporated herein by reference.

### BACKGROUND ART

There is a high-pressure pump (high-pressure fluid pump) used in a common rail type fuel injection system in a diesel engine, which includes a piston that reciprocates in a piston chamber in conjunction with a cam shaft and a flow path shutoff electromagnetic valve provided in a discharge flow path. A discharge valve that discharges high-pressure fuel to the fuel injection device is provided on the downstream side of the discharge flow path. The discharge principle of the high-pressure pump is as follows. The flow path shutoff electromagnetic valve is kept in a valve-open state when not driven, and the flow path shutoff electromagnetic valve is closed during the piston ascending stroke. In this manner, the pressure in the piston chamber is increased, and when the pressure on the upstream side of the discharge valve exceeds the pressure on the downstream side of the discharge valve, the high-pressure fuel is discharged from the discharge valve. In general, the flow path shutoff electromagnetic valve is fixed to the pump housing, and a contact surface with the pump housing is sealed so that the fuel does not leak during pressurization.

In the above-described fuel injection system, while the internal pressure of the piston chamber periodically changes between the low pressure and the high pressure when the high-pressure pump is driven, the low pressure and the high pressure also periodically change inside the housing of the flow path shutoff electromagnetic valve. Therefore, the valve member accommodated inside the housing is elastically deformed by the repeated action of the low pressure and the high pressure, and relative slippage occurs on the surface where the valve member forms the inner wall surface and the seal surface of the housing. When relative slippage occurs, there is a possibility that fretting wear may occur. Then, if the fretting wear grows, there is a concern that the sealing function of the flow path shutoff electromagnetic valve may be impaired.

PTL 1 discloses the above-described flow path shutoff electromagnetic valve. In this flow path shutoff electromagnetic valve, a valve member that forms a fuel flow path is accommodated inside a housing, and the valve member abuts against an inner surface of the housing to form a seal surface around the fuel path. In addition, it is described that the relative deformation amount between two surfaces forming the seal surface is reduced by forming the concave part on the seal surface of the valve member facing the concave part formed on the seal surface on the housing side.

### CITATION LIST

### Patent Literature

[PTL 1] PCT Japanese Translation Patent Publication No. 2014-524541

### SUMMARY OF INVENTION

### Technical Problem

As disclosed in PTL 1, it is considered that it is difficult to significantly reduce the relative deformation amount between the two surfaces forming the seal surface only by means for forming the concave parts on the two surfaces forming the seal surface and facing each other between the valve member accommodated in the housing and the housing inner surface, and thus, a more effective improvement countermeasure is desired.

The present disclosure has been made in view of the above-described circumstances, and an object of the present disclosure is to further improve the effect of suppressing fretting wear that occurs in a flow path shutoff electromagnetic valve provided in a discharge flow path of a high-pressure fluid pump.

### Solution to Problem

In order to achieve the above object, an aspect of a discharge control device according to the present disclosure is a discharge control device for controlling discharge of a high-pressure fluid discharged from a discharge valve via a discharge flow path from a high-pressure fluid pump, the device including: a housing having a pressure space communicating with the discharge flow path on one side in an axial direction; a valve body disposed to be movable along the axial direction inside the housing, the valve body being disposed such that one-side end surface of the valve body faces the pressure space; an anchor member disposed on an outer peripheral side of the valve body inside the housing and slidingly supporting the valve body, the anchor member having a valve seat surface that comes into contact with the valve body when the valve body moves to the other side in the axial direction, the valve seat surface being formed on an inner peripheral surface; and the discharge control device being configured such that when the valve body moves to the one side from a state where the valve body is in contact with the valve seat surface, the high-pressure fluid in the pressure space is discharged to the outside from a position on the other side of the valve seat surface in a gap between the inner peripheral surface of the anchor member and an outer peripheral surface of the valve body, in which the housing has a concave part formed on one-side internal end surface inside the housing, the concave part defining the pressure space between the concave part and the one-side end surface of the valve body, the one-side end surface of the anchor member has a first seal part that forms a seal surface by coming into contact with the one-side internal end surface of the housing, and a first recessed part that is an annular recess formed on an outer peripheral side of the first seal part, and the one-side internal end surface of the housing has a second seal part that forms the seal surface by coming into contact with the first seal part, and a second recessed part that is an annular recess formed on an outer peripheral side of the second seal part and facing the first recessed part.

### Advantageous Effects of Invention

According to one aspect of the discharge control device according to the present disclosure, even when the pressure in the pressure space formed inside the housing and communicating with the discharge flow path fluctuates, it is possible to approximate the relative deformation amounts in the radial direction between the first seal part on the anchor member side and the second seal part on the housing side, which form the seal surfaces with each other. In this manner, the fretting wear of the seal surface that is caused by a difference in the amount of radial elastic deformation of the first seal part and the second seal part forming the seal surface can be effectively suppressed.

### BRIEF DESCRIPTION OF DRAWINGS

FIG. 1 is a longitudinal sectional view of a discharge control device according to an embodiment.

FIG. 2 is an enlarged longitudinal sectional view of a portion A of the discharge control device in a valve-open state shown in FIG. 1.

FIG. 3 is a longitudinal sectional view showing a state where a valve of the discharge control device shown in FIG. 2 is closed.

FIG. 4 is a front view of one-side end surface of an anchor member as viewed in a direction of an arrow B in FIG. 2.

FIG. 5 is a diagram corresponding to FIG. 2 and is a description diagram used to describe the shapes of the respective parts of the discharge control device illustrated in FIG. 2.

### DESCRIPTION OF EMBODIMENTS

Hereinafter, some embodiments of the present invention will be described with reference to the accompanying drawings. Dimensions, materials, shapes, and relative dispositions of components described in the embodiments or illustrated in the drawings are not intended to limit the scope of the present invention, and are merely examples for description.

For example, an expression representing a relative or absolute disposition such as “in a certain direction”, “along a certain direction”, “parallel”, “orthogonal”, “center”, “concentric”, or “coaxial” does not strictly represent only such a disposition, but also a state of being relatively displaced with tolerance or an angle or a distance to the extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven part or a chamfered part within a range where the same effect can be obtained.

Meanwhile, expressions “being provided with”, “being equipped with”, “including”, or “having” one component are not exclusive expressions excluding the presence of other components.

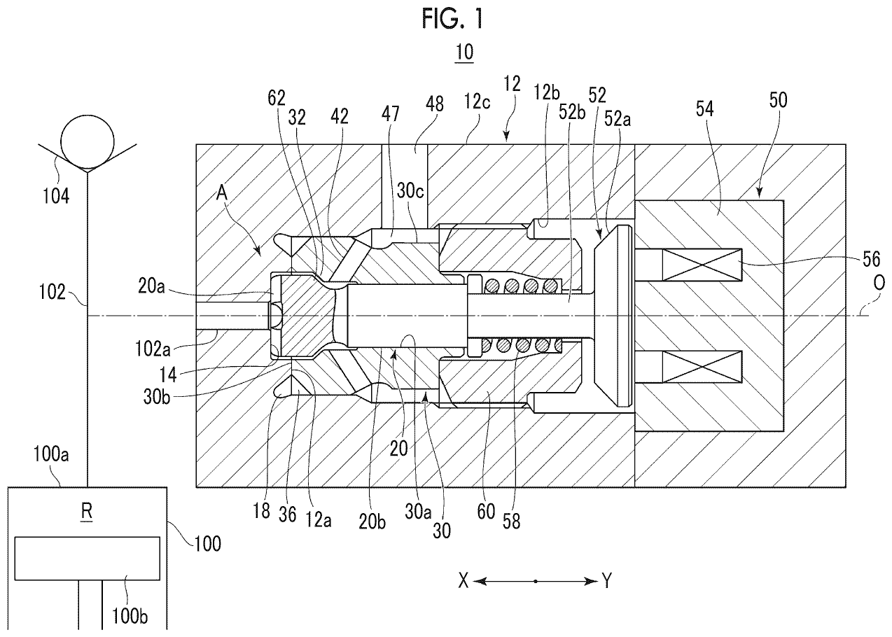

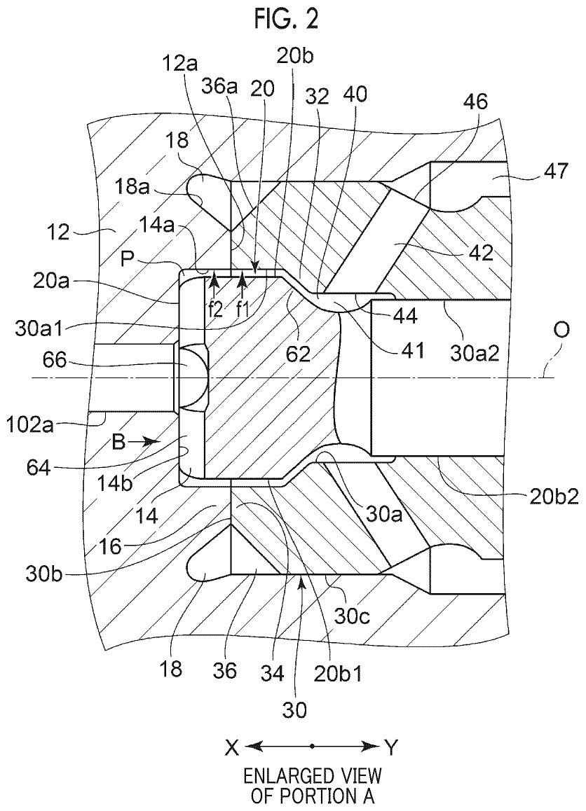

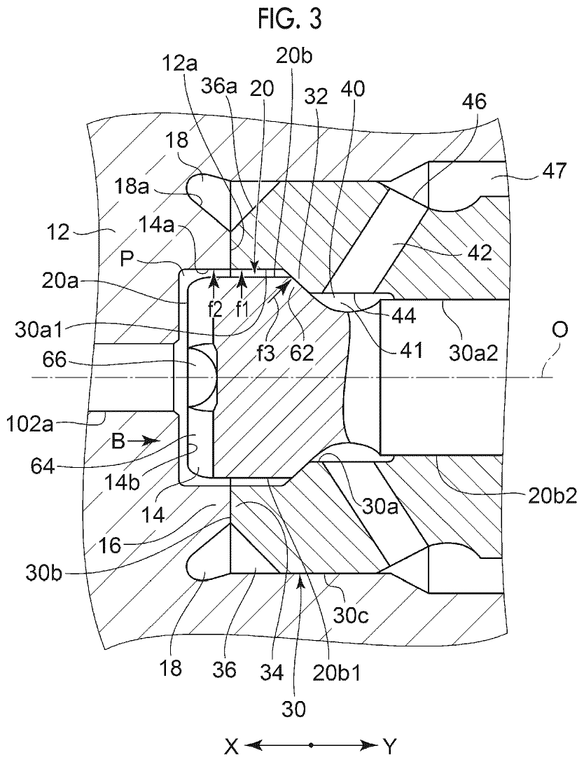

FIG. 1 is a longitudinal sectional view of a discharge control device 10 according to an embodiment. FIG. 2 is an enlarged view of a portion A of the discharge control device 10 shown in FIG. 1, and is a longitudinal sectional view showing that the discharge control device 10 is in a valve-open state. FIG. 3 is a longitudinal sectional view showing a state where the discharge control device 10 is in a valve-closed state, which corresponds to FIG. 2.

As shown in FIG. 1, a discharge flow path 102 is connected between the high-pressure fluid pump 100 and the discharge valve 104. The discharge valve 104 is configured to be, for example, a check valve, and is configured to open when the pressure of the high-pressure fluid flowing through the discharge flow path 102 exceeds the pressure on the downstream side of the discharge valve 104. The discharge control device 10 performs discharge control (for example, control of a discharge timing, control of a discharge amount, or the like) of a high-pressure fluid discharged from the discharge valve 104 via the discharge flow path 102 from the high-pressure fluid pump 100.

A pressure space P that communicates with the discharge flow path 102 on one side (X-direction side in FIG. 1) in the axial direction of the central axis O is formed inside the housing 12 of the discharge control device 10. The valve body 20 is disposed inside the housing 12 so as to be movable along the axial direction of the housing 12 (hereinafter, also simply referred to as an “axial direction”). As shown in FIG. 3, one-side end surface 20a of the valve body 20, which is an end surface on one side in the axial direction, is disposed to face the pressure space P. Further, inside the housing 12, the anchor member 30 is disposed to surround the valve body 20 on the outer peripheral side of the valve body 20, and the anchor member 30 supports the valve body 20 to be slidable along the axial direction.

As shown in FIG. 2, a valve seat surface 32 with which the valve body 20 comes into contact when the valve body 20 moves to the other side (Y-direction side in FIG. 1) in the axial direction is formed on the inner peripheral surface 30a of the anchor member 30. In addition, a flow path 40 is formed in a gap between the inner peripheral surface 30a of the anchor member 30 and the outer peripheral surface 20b of the valve body 20 on the other side (Y-direction side in FIG. 2) from the valve seat surface 32.

In the exemplary embodiment illustrated in FIG. 1, the high-pressure fluid pump 100 is a reciprocating pump in which a piston chamber R is formed inside a cylinder 100a and a piston 100b reciprocates in the piston chamber R.

In addition, the high-pressure fluid pump 100 is used, for example, in a common rail type fuel injection system in a diesel engine. In the case of the reciprocating pump, the piston 100b reciprocates in the piston chamber in conjunction with a cam shaft (not shown). Then, the discharge control device 10 is kept in a valve-closed state, the pressure of the fuel in the discharge flow path 102 is increased in the piston ascending stroke, and when the pressure on the upstream side of the discharge valve 104 exceeds the pressure on the downstream side of the discharge valve 104, the high-pressure fuel is discharged from the discharge valve 104.

That is, when an electromagnetic actuator 50 (to be described later) is operated during the ascending stroke of the piston surface 24a, an electromagnetic force that draws the valve body 20 to the Y-direction side is generated. When the valve body 20 (an abutment part 62 described later in the embodiment illustrated in FIG. 2) is moved to the Y-direction side by the electromagnetic force or the like and is in a state of abutting against the valve seat surface 32, the pressure space P is shut off from the flow path 40 (valve-closed state). At this time, the fluid pressure in the pressure space P and the fluid pressure in the discharge flow path 102 are increased by the fluid discharged from the high-pressure fluid pump 100 to the discharge flow path 102, and when the fluid pressure in the discharge flow path 102 exceeds the pressure on the downstream side of the discharge valve 104, the discharge valve 104 is opened, and the high-pressure fluid is discharged to the downstream side of the discharge valve 104. In addition, since the pressure of the discharge flow path 102 acts on the valve body 20 even after the operation of the electromagnetic actuator 50 is stopped for a while after the valve is closed, the valve-closed state is maintained.

When the piston 100b moves to the descending stroke, the discharge from the discharge valve 104 is stopped, and the discharge valve 104 is closed by the pressure on the downstream side. As the descending stroke increases, the pressure in the discharge flow path 102 or the pressure space P decreases, and the valve body 20 moves to one side (X direction in FIG. 2) from a state of abutting against the valve seat surface 32. The pressure space P communicates with the flow path 40 (valve-open state), and a low-pressure fluid is supplied into the piston chamber R through a supply and discharge hole 42, the pressure space P, the discharge flow path 102, and the like from the supply and discharge hole 48 to be described later.

As shown in FIG. 2, a concave part 14 is formed on one-side internal end surface 12a of the housing 12, which is one-side end surface in the axial direction, inside the housing 12. The concave part 14 defines a pressure space P between the concave part 14 and the one-side end surface 20a of the valve body 20. The anchor member 30 has a first seal part 34 that forms a seal surface by abutting against the one-side internal end surface 12a of the housing 12, the one-side end surface 30b that is the end surface on the one side in the axial direction of the anchor member 30. On the other hand, the one-side internal end surface 12a of the housing 12 has a second seal part 16 that abuts against the first seal part 34 to form a seal surface. A first recessed part 36 formed of an annular recess is formed on the outer peripheral side of the first seal part 34 of the anchor member 30, and a second recessed part 18 formed of an annular recess and facing the first recessed part 36 is formed on the outer peripheral side of the second seal part 16 on the one-side internal end surface 12a of the housing 12.

In the above configuration, when the valve body 20 abuts against the valve seat surface 32 and the flow path space is blocked between the pressure space P and the flow path 40, the pressure space P communicating with the discharge flow path 102 is pressurized. Therefore, the first seal part 34 of the anchor member 30 receives the force f1 acting on the outer peripheral side due to the fluid pressure. The first seal part 34 is elastically deformed to the outer peripheral side by receiving the force f1. On the other hand, since a force f2 acting on the outer peripheral side is also applied to the side surface 14a of the concave part 14 by the fluid pressure, the second seal part 16 is also elastically deformed to the outer peripheral side by receiving the force f2. In this way, the second seal part 16 is also elastically deformed to the outer peripheral side by forming the concave part 14. Therefore, the relative deformation amount between the first seal part 34 and the second seal part 16 can be reduced (first reduction effect).

Further, since the second recessed part 18 is formed on the outer peripheral side of the second seal part 16 so as to face the first recessed part 36 formed on the outer peripheral side of the first seal part 34, the shape of the one-side internal end surface 12a of the housing 12 can be approximated to the shape of the one-side end surface 30b of the anchor member 30 on the outer peripheral side with respect to the seal surface. In this manner, the elastic deformation amount of the second seal part 16 on the housing 12 side in the radial direction (hereinafter, also simply referred to as a “radial direction”) of the housing 12 can be approximated to the elastic deformation amount of the first seal part 34 on the anchor member 30 side in the radial direction (second reduction effect). In this way, the fretting wear that occurs on the seal surface can be effectively reduced by the integrated effect of the first reduction effect and the second reduction effect.

In the exemplary embodiment illustrated in FIG. 1, a branch pipe 102a configuring a branch flow path branched from the discharge flow path 102 is connected to one-side end surface of the housing 12, and the discharge flow path 102 communicates with the pressure space P.

In addition, in the exemplary embodiment illustrated in FIG. 2, the first recessed part 36 has an annular inclined surface 36a that is formed to precisely process an inner peripheral surface 30a2 of the anchor member 30 for the slidable support of the outer peripheral surface 20b2 of the valve body 20 during processing of the anchor member 30 as will be described later. In addition, in a cross section along the axial direction, the inclined surface 36a is formed in a linear shape, and the first recessed part 36 forms a right triangle including the inclined surface 36a as one side. By forming the inclined surface 36a, a high sealing pressure can be generated on the seal surface formed by the first seal part 34 and the second seal part 16, and the sealing effect can be enhanced.

In addition, as shown in FIG. 1, an electromagnetic actuator 50, which is a drive device for reciprocating the valve body 20 along the axial direction, is provided on the other side of the valve body 20 in the axial direction. The electromagnetic actuator 50 includes an armature 52 that is integrally connected to the other end surface of the valve body 20 in the axial direction, and a stator core 54 that is provided inside the housing 12 on the other side in the axial direction of the armature 52. The stator core 54 incorporates a solenoid coil 56 wound in a coil shape inside. The armature 52 includes an enlarged diameter part 52a disposed to face the stator core 54, and a shaft part 52b that is formed integrally with the enlarged diameter part 52a and is disposed to extend along the axial direction on the central axis O. In addition, a coil-shaped spring member 58 is provided around the shaft part 52b to surround the shaft part 52b. The spring member 58 urges a spring force to the valve body 20 in a direction (X direction) in which the valve body 20 is pressed against the bottom surface 14b of the concave part 14 with respect to the valve body 20.

When the electromagnetic actuator 50 is not in operation, the one-side end surface 20a of the valve body 20 abuts against the bottom surface 14b of the concave part 14 due to the spring force of the spring member 58. At this time, the valve body 20 is separated from the valve seat surface 32 toward the X-direction side, and thus the pressure space P communicates with the flow path 40. Therefore, the fluid flowing into the pressure space P from the discharge flow path 102 flows out to the outside of the housing 12 through the flow path 40 from the pressure space P, and thus the discharge flow path 102 and the pressure space P do not become high pressure.

When the solenoid coil 56 is energized when the piston 100b ascends, the solenoid coil 56 generates a magnetic flux, and an electromagnetic force that pulls the armature 52 toward the stator core 54 side is generated in the stator core 54. In this manner, the valve body 20 moves to the Y-direction side together with the armature 52, and the valve body 20 abuts against the valve seat surface 32, so that the pressure space P and the flow path 40 are blocked. When the fluid is discharged from the high-pressure fluid pump 100 in a state where the pressure space P and the flow path 40 are blocked, the fluid pressure in the pressure space P and the discharge flow path 102 becomes high, and the discharge valve 104 is opened.

In the exemplary embodiment illustrated in FIG. 1, the retaining nut 60 is provided on the outer peripheral side of the spring member 58. The outer peripheral surface of the retaining nut 60 and the inner peripheral surface of the housing 12 are screwed to each other, one-side end surface of the retaining nut 60 locks the other end surface of the anchor member 30, and the retaining nut 60 stably supports the anchor member 30 in a state where the first seal part 34 and the second seal part 16 form a seal surface.

In one embodiment, as shown in FIG. 2, the anchor member 30 is formed with a supply and discharge hole 42 (discharge hole) that communicates with the pressure space P via the flow path 40 on the other side in the axial direction with respect to the valve seat surface 32. The supply and discharge hole 42 has a first opening 44 that opens to the pressure space P via the flow path 40, and a second opening 46 that opens to the outer peripheral surface 30c of the anchor member 30. In addition, the abutment part 62 is formed on the outer peripheral surface 20b of the valve body 20. The abutment part 62 is configured to abut against the valve seat surface 32 when the valve body 20 moves to the Y-direction side, and to block the pressure space P and the first opening 44.

In the reciprocating high-pressure fluid pump 100 including the piston 100b shown in FIG. 1, when the valve body 20 is in the valve-open state, the fluid in the piston chamber is discharged from the supply and discharge hole 42 through the discharge flow path 102, the pressure space P, and the like during the ascending stroke of the piston 100b. Then, the fluid that can flow in from the supply and discharge hole 48 to be described later during the descending stroke of the piston 100b is supplied to the piston chamber R via the pressure space P, the discharge flow path 102, and the like from the supply and discharge hole 42.

According to the present embodiment, the supply and discharge path of the fluid that communicates with the pressure space P and is formed on the Y-direction side with respect to the valve seat surface 32 can be formed by the supply and discharge hole 42. Therefore, the formation of the supply and discharge path is facilitated. In addition, the valve function of the valve body 20 for allowing the pressure space P and the flow path 40 to communicate with or block each other can be realized with a simple configuration in which the abutment part 62 is formed on the outer peripheral surface 20b of the valve body 20.

In the exemplary embodiment illustrated in FIG. 2, the first opening 44 is disposed on the Y-direction side with respect to the valve seat surface 32. Therefore, when the abutment part 62 abuts against the valve seat surface 32, the pressure space P and the first opening 44 are blocked. In addition, since a fluid reservoir 41 facing the first opening 44 and having a large cross-sectional area in the direction orthogonal to the axial direction is formed, the circulation of the fluid between the pressure space P and the first opening 44 becomes smooth.

In the exemplary embodiment illustrated in FIG. 1, the supply and discharge holes 48 that are open to the inner peripheral surface 12b and the outer peripheral surface 12c of the housing 12 are formed. The supply and discharge hole 48 is formed along a direction orthogonal to the central axis O on the outer peripheral side of the anchor member 30, and communicates with the flow path 40 via a flow path 47 having a large cross-sectional area. Therefore, when the valve body 20 is in the valve-open state and the piston 100b is in the ascending stroke, the fluid that has flowed into the flow path 47 from the pressure space P through the flow path 40 and the supply and discharge hole 42 is smoothly discharged from the flow path 47 to the outside of the housing 12 through the supply and discharge hole 48. On the other hand, when the valve body 20 is in the valve-open state and the piston 100b is in the descending stroke, the fluid is smoothly supplied to the pressure space P side from the supply and discharge hole 48 through the flow path 47, the supply and discharge hole 42, and the flow path 40.

In one embodiment, as shown in FIG. 2, the valve seat surface 32 and the abutment part 62 are each configured to be an inclined surface that is inclined in a direction intersecting the central axis O toward the other side (Y-direction side) in a cross section including the central axis O of the housing 12.

According to the present embodiment, since the valve seat surface 32 and the abutment part 62 are configured with the inclined surface, when the abutment part 62 abuts against the valve seat surface 32, the sealing degree of the abutting surface can be improved. When the abutment part 62 abuts against the valve seat surface 32, as shown in FIG. 3, a force f3 that acts outward in the radial direction from the abutment part 62 to the valve seat surface 32 is generated. The force f3 increases the deformation amount by which the first seal part 34 is deformed outward in the radial direction, and there is a concern that the fretting wear of the seal surface may increase. However, according to the discharge control device 10 of the present embodiment, since the fretting wear can be effectively suppressed, even in a case where the valve seat surface 32 and the abutment part 62 have the above-described inclined surface, the fretting wear of the seal surface can be sufficiently suppressed.

In the exemplary embodiment illustrated in FIG. 2, the inner peripheral surface 30a of the anchor member 30 includes an inner peripheral surface 30al formed on the X-direction side with respect to the valve seat surface 32, and an inner peripheral surface 30a2 formed on the Y-direction side with respect to the valve seat surface 32 and having a smaller diameter than the inner peripheral surface 30a1.

On the other hand, the outer peripheral surface 20b of the valve body 20 includes an outer peripheral surface 20b1 disposed to face the inner peripheral surface 30al of the anchor member 30, and an outer peripheral surface 20b2 formed on the Y-direction side with the abutment part 62 interposed between the outer peripheral surface 20b1 and the outer peripheral surface 20b2. The outer peripheral surface 20b2 is disposed to face the inner peripheral surface 30a2 of the anchor member 30, and has a smaller diameter than the outer peripheral surface 20b1. A pressure space P is formed between the inner peripheral surface 30al of the anchor member 30 and the outer peripheral surface 20b1 of the valve body 20, and the outer peripheral surface 20b2 of the valve body 20 is slidably supported by the inner peripheral surface 30a2 of the anchor member 30.

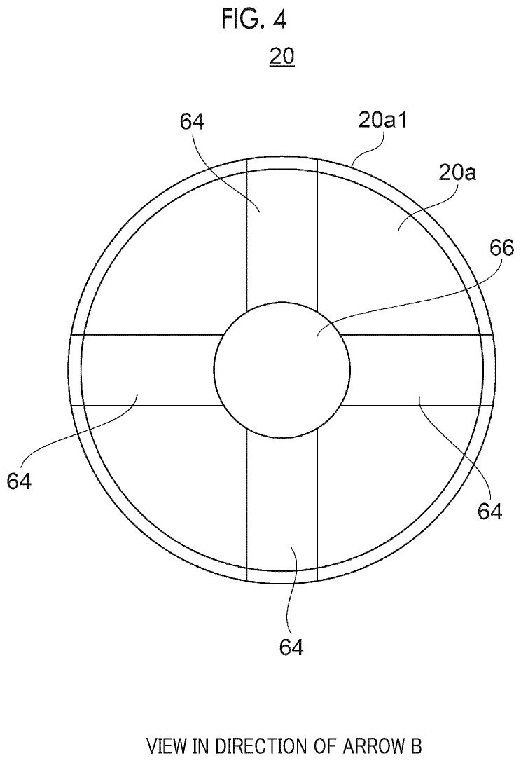

In one embodiment, as shown in FIG. 4, a groove part 64 is formed on the one-side end surface 20a of the valve body 20. At least a part of the groove part 64 is disposed to face the outlet opening through which the branch pipe 102a is open to the one-side internal end surface 12a of the housing 12 when the one-side end surface 20a abuts on the bottom surface 14b of the concave part 14. In addition, at least one end side of the groove part 64 extends to the outer peripheral edge 20al of the one-side end surface 20a.

According to the present embodiment, since the groove part 64 is provided, even when the one-side end surface 20a of the valve body 20 abuts on the bottom surface 14b of the concave part 14 facing the one-side end surface 20a, a state where the discharge flow path 102 and the pressure space P communicate with each other can be maintained.

In the exemplary embodiment illustrated in FIG. 4, the groove part 64 is composed of four slit-shaped grooves formed on the one-side end surface 20a with an angle difference of approximately 90°. A circular concave part 66 is formed in a central part of the one-side end surface 20a, and the four groove parts 64 are formed in a slit shape in a straight line from the central part toward the peripheral part, and the four groove parts 64 are respectively connected to the concave part 66 in the central part of the one-side end surface 20a. Since the groove parts 64 are formed in such a shape, the high-pressure fluid flowing into the pressure space P from the branch pipe 102a flows through the four slit-shaped groove parts and reaches the outer peripheral surface 20b of the valve body 20, and flows into the pressure space P uniformly in the circumferential direction of the valve body 20.

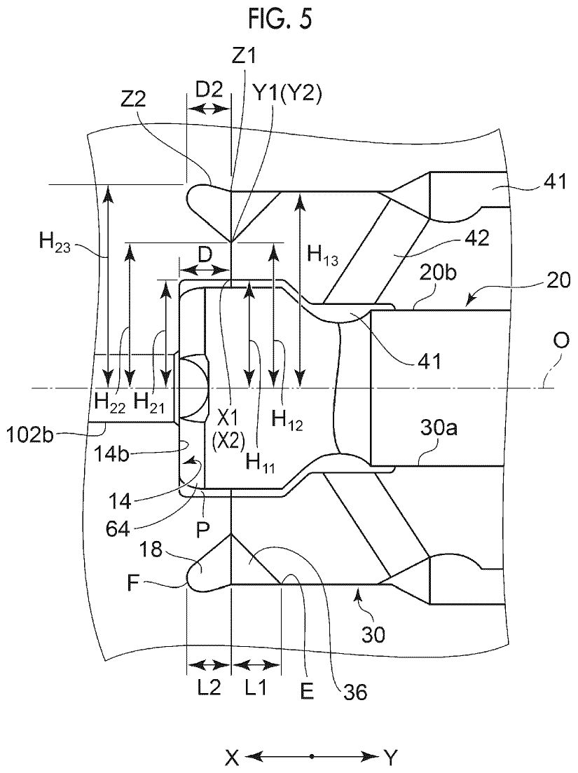

FIG. 5 is a view corresponding to FIG. 2 and is a view for describing dimensions of shapes of respective parts in the discharge control device 10 illustrated in FIG. 2.

In one embodiment, as shown in FIG. 5, in a cross section including the central axis O, when a distance between a deepest part of the concave part 14 and the seal surface is D and a distance between a deepest part of the second recessed part 18 and the seal surface is D2, in the present embodiment, the distance D and the distance D2 have a relationship of the following Expression (1).

$$0.5 D \leq D 2 \qquad ( 1 )$$

By forming the concave part 14, the elastic deformation of the second seal part 16 to the outer peripheral side is generated. In addition, in the present embodiment, since the distance D2 between the deepest part of the second recessed part 18 and the seal surface satisfies the above Expression (1), the second recessed part 18 has a depth sufficient to approximate the elastic deformation amount of the second seal part 16 to the outer side in the radial direction to the elastic deformation amount of the first seal part 34 to the outer side in the radial direction. In this manner, the radial deformation amount of the second seal part 16 can be made close to the radial deformation amount of the first seal part 34. Therefore, the relative deformation amount between the first seal part 34 and the second seal part 16 can be reduced, and the fretting wear of the seal surface can be effectively suppressed.

In the exemplary embodiment illustrated in FIG. 5, the bottom surface 14b of the concave part 14 forms a plane orthogonal to the central axis O. Therefore, the deepest part of the concave part 14 is the bottom surface 14b. In addition, the deepest part of the first recessed part 36 is a point E, and the deepest part of the second recessed part 18 is a point F.

In another embodiment, in a cross section including the central axis O, a distance D between a deepest part of the concave part 14 and the seal surface and a distance D2 between a deepest part of the second recessed part 18 and the seal surface have a relationship of Expression (2) below.

$$0.7 D \leq D 2 \leq 1.3 D \qquad ( 2 )$$

In this embodiment, the distance D has a value closer to the distance D2 than in the above-described embodiment. Therefore, the depth of the second recessed part 18 is sufficient to generate the deformation amount of the first seal part 34 to the radial outer side, and the deformation amount of the second seal part 16 in the radial direction can be made closer to the deformation amount of the first seal part 34 in the radial direction than in the above-described embodiment. In this manner, the relative deformation amount between the first seal part 34 and the second seal part 16 can be further reduced, and the fretting wear of the seal surface can be further effectively suppressed.

In one embodiment, as shown in FIG. 2, in a cross section including the central axis O of the housing 12, the wall surface 18a on the radial inner side forming the second recessed part 18 includes an inclined surface inclined radially outward toward one side (X-direction side).

According to the present embodiment, since the wall surface 18a on the radial inner side forming the second recessed part 18 includes the above-described inclined surface, the dimension of the second seal part 16 in the radial direction can be sufficiently secured, and thereby, while the strength of the second seal part 16 can be secured, the amount of radial elastic deformation of the second seal part 16 can be made close to the amount of radial elastic deformation of the first seal part 34. Therefore, the relative deformation amount of the seal surface can be reduced, and the fretting wear of the seal surface can be suppressed.

In the exemplary embodiment illustrated in FIG. 2, in a cross section including the central axis O of the housing 12, the second recessed part 18 has a shape similar to that of a vertical tail of an airplane, so to speak, including a wall surface 18a having a linear inclined surface on the radial inner side and an arc-shaped wall surface on the radial outer side. In this manner, while the strength of the second seal part 16 of the housing 12 is secured, the radial elastic deformation amount of the second seal part 16 can be made close to the radial elastic deformation amount of the first seal part 34. Therefore, the relative deformation amount of the seal surface can be reduced, and the fretting wear of the seal surface can be suppressed.

In one embodiment, as shown in FIG. 5, in a cross section including the central axis O, a ratio (H₂₁/H₁₁) of a distance H₁₁ between the radial inner end X1 of the first seal part 34 and the central axis O and a distance H₂₁ between the radial inner end X2 of the second seal part 16 and the central axis O is 0.95 or more and 1.05 or less.

In addition, a ratio (H₂₂/H₁₂) of a distance H₁₂ between the radial outer end Y1 of the first seal part 34 and the central axis O and a distance H₂₂ between the radial outer end Y2 of the second seal part 16 and the central axis O is 0.95 or more and 1.05 or less.

In addition, a ratio (H₂₃/H₁₃) of a distance H₁₃ between the radial outer end Z1 of the first recessed part 36 and the central axis O and a distance H₂₃ between the radial outer end Z2 of the second recessed part 18 and the central axis O is 0.95 or more and 1.05 or less.

Further, a ratio (L2/L1) of a distance L1 from the seal surface of the first recessed part 36 to the deepest part E and a distance L2 from the seal surface of the second recessed part 18 to the deepest part F is 0.95 or more and 1.05 or less.

According to the present embodiment, in the cross section including the central axis O, the cross section of the first recessed part 36 and the cross section of the second recessed part 18 have substantially symmetrical shapes with the seal surface as a center. In this manner, the effect of promoting deformation of the first seal part 34 to the radial outer side due to the presence of the first recessed part 36 and the effect of promoting deformation of the second seal part 16 to the radial outer side due to the presence of the second recessed part 18 can be made substantially the same. Therefore, the relative deformation amount in the radial direction of the first seal part 34 and the second seal part 16 can be reduced, and the fretting wear of the seal surface can be suppressed.

In the exemplary embodiment illustrated in FIGS. 2, H₁₁=H₂₁ and H₁₂=H₂₂, and the radial outer end Z2 of the second recessed part 18 is located slightly outside the radial outer end Z1 of the first recessed part 36. Therefore, H₁₃≈H₂₃. Therefore, the cross section of the first recessed part 36 and the cross section of the second recessed part 18 have substantially symmetrical shapes. Therefore, the effect of promoting the deformation of the first seal part 34 to the radial outer side by the first recessed part 36 and the effect of promoting the deformation of the second seal part 16 to the radial outer side by the second recessed part 18 can be made substantially the same. Therefore, the relative deformation amount in the radial direction of the first seal part 34 and the second seal part 16 can be reduced, and the fretting wear of the seal surface can be suppressed.

The contents described in each embodiment are understood as follows, for example.

1) A discharge control device (10) according to one aspect is a discharge control device (10) for controlling discharge of a high-pressure fluid pump (100) via a discharge flow path (102) through a discharge valve (104), the discharge control device (10) including: a housing (12) having a pressure space (P) communicating with the discharge flow path (102) on one side in an axial direction; a valve body (20) disposed to be movable along the axial direction inside the housing (12), the valve body (20) being disposed such that one-side end surface (20a) of the valve body (20) faces the pressure space (P); and an anchor member (30) disposed on an outer peripheral side of the valve body (20) inside the housing (12) and slidingly supporting the valve body (20), the anchor member (30) having a valve seat surface (32) that abuts against the valve body (20) when the valve body (20) moves to the other side in the axial direction, the valve seat surface (32) being formed on an inner peripheral surface (30a), in which the discharge control device (10) is configured such that when the valve body (20) moves to the one side from a state where the valve body (20) is abutting against the valve seat surface (32), the high-pressure fluid in the pressure space (P) is discharged to the outside from a position on the other side of the valve seat surface (32) in a gap between the inner peripheral surface (30a) of the anchor member (30) and an outer peripheral surface (20b) of the valve body (20), the housing (12) has a concave part (14) formed on one-side internal end surface (12a) inside the housing (12), the concave part (14) defining the pressure space (P) between the concave part (14) and the one-side end surface (20a) of the valve body (20), the one-side end surface (30b) of the anchor member (30) has a first seal part (34) that abuts against the one-side internal end surface (12a) of the housing (12) to form a seal surface, and a first recessed part (36) that is an annular recess formed on an outer peripheral side of the first seal part (34), and the one-side internal end surface (12a) of the housing (12) has a second seal part (16) that abuts against the first seal part (34) to form the seal surface, and a second recessed part (18) that is an annular recess formed on an outer peripheral side of the second seal part (16) and facing the first recessed part (36).

In the above configuration, when the valve body (20) moves to one side from a state of abutting against the valve seat surface (32) and is separated from the valve seat surface (32) (when the valve is opened), the fluid discharged from the high-pressure fluid pump (100) to the discharge flow path (102) flows from the pressure space (P) to the other side of the valve seat surface (32) and flows out to the outside of the housing (12). Therefore, the fluid pressure in the discharge flow path (102) and the pressure space (P) does not reach a pressure at which the discharge valve (104) can be opened. When the valve body (20) moves to the other side and abuts against the valve seat surface (32), the pressure space (P) and the flow path (40) formed on the other side of the valve seat surface (32) are blocked. Therefore, the fluid discharged from the high-pressure fluid pump (100) causes the discharge flow path (102) and the pressure space (P) to reach or exceed the pressure that opens the discharge valve (104), thereby opening the discharge valve (104).

In the discharge control device (10), the concave part (14) is formed on the one-side internal end surface (12a) of the housing (12). Therefore, the fluid pressure acting on the outer peripheral side is applied not only to the inner peripheral surface (30a) of the anchor member (30) but also to the side surface (14a) of the concave part (14). In this manner, the deformation amount by which the first seal part (34) on the anchor member (30) side is elastically deformed toward the outer peripheral side and the deformation amount by which the second seal part (16) on the housing (12) side forming the seal surface with the first seal part (34) is elastically deformed toward the outer peripheral side are approximated to each other. Therefore, a relative deformation amount between the first seal part (34) and the second seal part (16) can be reduced (first reduction effect).

Furthermore, the second recessed part (18) is formed on the outer peripheral side of the second seal part (16) so as to face the first recessed part (36) formed on the outer peripheral side of the first seal part (34). In this manner, the shape of the one-side internal end surface (12a) of the housing (12) can be approximated to the shape of the one-side end surface (30b) of the anchor member (30) on the outer peripheral side with respect to the seal surface. In this manner, the radial elastic deformation amount of the second seal part (16) on the housing (12) side can be approximated to the radial elastic deformation amount of the first seal part (34) on the anchor member (30) side (second reduction effect).

In this way, the fretting wear that occurs on the seal surface can be effectively reduced by the integrated effect of the first reduction effect and the second reduction effect.

2) The discharge control device (10) according to another aspect is the discharge control device (10) according to 1), in which the anchor member (30) has a discharge hole (42) having a first opening (44) that is open to the pressure space (P) on the other side of the valve seat surface (32) and a second opening (46) that is open to an outer peripheral surface (30c) of the anchor member (30), and the valve body (20) has an abutment part (62) that abuts against the valve seat surface (32) to block the pressure space (P) and the first opening (44) when the valve body (20) moves to the other side on the outer peripheral surface (20b) of the valve body (20).

According to such a configuration, since the discharge path for discharging the fluid flowing through the pressure space (P) to the outer peripheral side of the anchor member (30) on the other side of the valve seat surface (32) can be formed by the discharge hole (42), the discharge path can be easily formed at low cost. In addition, a simple configuration in which the abutment part (62) capable of abutting against the valve seat surface (32) is formed on the outer peripheral surface (20b) of the valve body (20) can realize a valve function of allowing the pressure space (P) and the discharge hole (42) to communicate with or be blocked from each other.

3) In the discharge control device (10) according to still another aspect, in the discharge control device (10) according to 2), each of the valve seat surface (32) and the abutment part (62) includes an inclined surface that is inclined in a direction intersecting with a central axis (O) of the housing (12) toward the other side in a cross section including the central axis (O).

According to such a configuration, since both the valve seat surface (32) and the abutment part (62) have the above-described inclined surface, when the valve seat surface (32) and the abutment part (62) abut against each other, the sealing degree of the abutting surface formed by the valve seat surface (32) and the abutment butting part (62) can be improved. When the abutment part (62) abuts against the valve seat surface (32), a force (f3) acting on the outer peripheral side from the abutment part (62) is generated, and the deformation amount by which the first seal part (34) of the anchor member (30) is elastically deformed to the radial outer side increases due to the force (f3), and there is a concern that fretting wear may increase. However, according to the discharge control device (10) according to the present disclosure, since the fretting wear can be effectively suppressed, even in a case where the abutment part (62) and the valve seat surface (32) have the above-described inclined surface, the fretting wear of the seal surface can be sufficiently suppressed.

4) The discharge control device (10) according to still another aspect is the discharge control device (10) according to any one of 1) to 3), in which the one-side end surface (20a) of the valve body (20) is provided with a groove part (64) that is at least partially facing an opening of the discharge flow path (102) when the one-side end surface (20a) abuts against a bottom surface (14b) of the concave part (14), and at least one end side of the groove part (64) extends to an outer peripheral edge of the one-side end surface (20a).

According to such a configuration, since the one-side end surface (20a) of the valve body (20) includes the groove part (64) having the above configuration, even when the one-side end surface (20a) of the valve body (20) abuts against the one-side internal end surface (12a) of the housing (12), the communication state between the discharge flow path (102) and the pressure space (P) can be maintained.

5) The discharge control device (10) according to still another aspect is the discharge control device (10) according to any one of 1) to 4), in which in a case where a distance between a deepest part of the concave part (14) and the seal surface in the axial direction is defined as D and a distance between a deepest part (F) of the second recessed part (18) and the seal surface is defined as D2, a relationship of 0.5D≤D2 (preferably, 0.7D≤D2≤1.3D) is satisfied.

According to such a configuration, the second recessed part (18) has a depth sufficient to approximate the elastic deformation amount of the second seal part (16) outward in the radial direction to the elastic deformation amount of the first seal part (34) outward in the radial direction. In this way, the elastic deformation amount of the second seal part (16) to the radial outer side can be approximated to the elastic deformation amount of the first seal part (34) to the radial outer side. Therefore, the relative deformation amount of the seal surface can be suppressed, and the fretting wear of the seal surface can be suppressed.

6) The discharge control device (10) according to still another aspect is the discharge control device (10) according to any one of 1) to 5), in which in a cross section including a central axis (O) of the housing (12), a wall surface (18a) on a radial inner side forming the second recessed part (18) includes an inclined surface that is inclined radially outward toward the one side.

According to such a configuration, since the wall surface (18a) on the radial inner side of the second recessed part (18) has the above-described inclined surface, it is possible to make the radial elastic deformation amount of the second seal part (16) close to the radial elastic deformation amount of the first seal part (34) without reducing the strength of the second seal part (16). In this manner, the relative deformation amount of the seal surface can be suppressed, and the fretting wear of the seal surface can be suppressed.

7) In the discharge control device (10) according to still another aspect, in the discharge control device (10) according to any one of 1) to 6), a ratio of a distance (H₁₁) between a radial inner end (X1) of the first seal part (34) and a central axis (O) of the housing (12) and a distance (H₂₁) between a radial inner end (X2) of the second seal part (16) and the central axis (O) is 0.95 or more and 1.05 or less, a ratio of a distance (H₁₂) between a radial outer end (Y1) of the first seal part (34) and the central axis (O) and a distance (H₂₂) between a radial outer end (Y2) of the second seal part (16) and the central axis (O) is 0.95 or more and 1.05 or less, a ratio of a distance (H₁₃) between a radial outer end (Z1) of the first recessed part (36) and the central axis (O) and a distance (H₂₃) between a radial outer end (Z2) of the second recessed part (18) and the central axis (O) is 0.95 or more and 1.05 or less, and a ratio of a distance (L1) from the seal surface to a deepest part (E) of the first recessed part (36) and a distance (L2) from the seal surface to a deepest part (F) of the second recessed part (18) is 0.95 or more and 1.05 or less.

According to such a configuration, in a cross section including the central axis (O) of the housing (12), the cross section of the first recessed part (36) and the cross section of the second recessed part (18) are substantially symmetrical with respect to the seal surface. In this manner, the effect of promoting the deformation of the first seal part (34) to the radial outer side by the first recessed part (36) and the effect of promoting the deformation of the second seal part (16) to the radial outer side by the second recessed part (18) can be made substantially the same. In this manner, the relative deformation amount of the first seal part (34) and the second seal part (16) in the radial direction can be reduced, and the fretting wear of the seal surface can be suppressed.

### REFERENCE SIGNS LIST

10: discharge control device
12: housing
12a: one-side internal end surface
12b: inner peripheral surface
12c: outer peripheral surface
14: concave part
14a: side surface
14b: bottom surface
16: second seal part
18: second recessed part
18a: wall surface
20: valve body
20a: one-side end surface
20b, 20b1, 20b2: outer peripheral surface
30: anchor member
30a, 30a1, 30a2: inner peripheral surface
30b: one-side end surface
30c: outer peripheral surface
32: valve seat surface
34: first seal part
36: first recessed part
36a: inclined surface
40, 47: flow path
42, 48: supply and discharge hole (discharge hole)
44: first opening
46: second opening
50: electromagnetic actuator
52: armature
52a: enlarged diameter part
52b: shaft part
54: stator core
56: solenoid coil
58: spring member
60: retaining nut
62: abutment part
64: groove part
66: concave part
100: high-pressure fluid pump
100a: cylinder
100b: piston
102: discharge flow path
102a: branch pipe
104: discharge valve
E, F: deepest part
O: central axis
P: pressure space
R: piston chamber

1. A discharge control device for controlling discharge of a high-pressure fluid pump via a discharge flow path through a discharge valve, the discharge control device comprising:
a housing having a pressure space communicating with the discharge flow path on one side in an axial direction;
a valve body disposed to be movable along the axial direction inside the housing, the valve body being disposed such that one-side end surface of the valve body faces the pressure space; and
an anchor member disposed on an outer peripheral side of the valve body inside the housing and slidingly supporting the valve body, the anchor member having a valve seat surface that abuts against the valve body when the valve body moves to the other side in the axial direction, the valve seat surface being formed on an inner peripheral surface,
wherein the discharge control device is configured such that when the valve body moves to the one side from a state where the valve body is abutting against the valve seat surface, the high-pressure fluid in the pressure space is discharged to the outside from a position on the other side of the valve seat surface in a gap between the inner peripheral surface of the anchor member and an outer peripheral surface of the valve body,
the housing has a concave part formed on one-side internal end surface inside the housing, the concave part defining the pressure space between the concave part and the one-side end surface of the valve body,
the one-side end surface of the anchor member has a first seal part that abuts against the one-side internal end surface of the housing to form a seal surface, and a first recessed part that is an annular recess formed on an outer peripheral side of the first seal part, and
the one-side internal end surface of the housing has a second seal part that abuts against the first seal part to form the seal surface, and a second recessed part that is an annular recess formed on an outer peripheral side of the second seal part and facing the first recessed part.

2. The discharge control device according to claim 1,
wherein the anchor member has a discharge hole having a first opening that is open to the pressure space on the other side of the valve seat surface and a second opening that is open to an outer peripheral surface of the anchor member, and
the valve body has an abutment part that abuts against the valve seat surface to block the pressure space and the first opening when the valve body moves to the other side on the outer peripheral surface of the valve body.

3. The discharge control device according to claim 2,
wherein each of the valve seat surface and the abutment part includes an inclined surface that is inclined in a direction intersecting with a central axis of the housing toward the other side in a cross section including the central axis.

4. The discharge control device according to claim 1,
wherein the one-side end surface of the valve body is provided with a groove part that is at least partially facing an opening of the discharge flow path when the one-side end surface abuts against a bottom surface of the concave part, and at least one end side of the groove part extends to an outer peripheral edge of the one-side end surface.

5. The discharge control device according to claim 1,
wherein in a case where a distance between a deepest part of the concave part and the seal surface in the axial direction is defined as D and a distance between a deepest part of the second recessed part and the seal surface is defined as D2, a relationship of 0.5D≤D2 is satisfied.

6. The discharge control device according to claim 1,
wherein, in a cross section including a central axis of the housing, a wall surface on a radial inner side forming the second recessed part includes an inclined surface that is inclined radially outward toward the one side.

7. The discharge control device according to claim 1,
wherein a ratio of a distance between a radial inner end of the first seal part and a central axis of the housing and a distance between a radial inner end of the second seal part and the central axis is 0.95 or more and 1.05 or less,
a ratio of a distance between a radial outer end of the first seal part and the central axis and a distance between a radial outer end of the second seal part and the central axis is 0.95 or more and 1.05 or less,
a ratio of a distance between a radial outer end of the first recessed part and the central axis and a distance between a radial outer end of the second recessed part and the central axis is 0.95 or more and 1.05 or less, and
a ratio of a distance from the seal surface to a deepest part of the first recessed part and a distance from the seal surface to a deepest part of the second recessed part is 0.95 or more and 1.05 or less.
